(19) United States
(12) Patent Application Publication
(10) Pub. No.: US 2002/0166954 A1
(43) Pub. Date: Nov. 14, 2002

(54) Method for generating activation energy and apparatus thereof

(76) Inventor: Kyung Hyun Min, Daegu (KR)

Correspondence Address: JACOBSON HOLMAN PLLC, 400 SEVENTH STREET N.W., SUITE 600, WASHINGTON, DC, 20004, US

(21) Appl. No.: 09/852,305

(22) Filed: May 10, 2001

(51) Int. Cl. G01J 3/50

(52) U.S. Cl. 250/226

(57) ABSTRACT

In a method for generating activation energy and an apparatus thereof, in which energy of specific wavelength is generated continuously from a specific substance during a level of filtered energy restores to a normal state, by filtering the energy of the specific wavelength to the specific substance and so heightening the energy level, it is characterized by such a construction that an energy filtering equipment for filtering energy of specific frequency is constructed in an energy radiating equipment for emitting the energy of specific frequency filtered for a constant period when the energy of the specific frequency is filtered, and that in such construction, an installment of the energy filtering equipment and its inspection process, a conveyor system interlocked with the energy filtering equipment through a time controlling equipment, and a forwarding inspection process are combined with one another, wherein the energy filtering equipment is automatically controlled by a process controlling computer operating by a process control terminal to which frequency corresponding to the energy level per radioactive substance, and its energy amount and a filtering time are gotten in program and are inputted.

### BACKGROUND OF THE INVENTION

1. Field of the Invention

The present invention relates to a method for generating activation energy and an apparatus thereof; and more particularly, to a method for generating activation energy and an apparatus thereof, in which energy of specific wavelength is generated continuously from a specific substance during a level of filtered energy restores to a normal state, by filtering the energy of the specific wavelength to the specific substance and so heightening the energy level.

2. Description of the Prior Art

Recently it has become known such a phenomenon that elementary particles such as a neutrino temporarily have a nature of a particle for an extremely short time, then do not have its nature, in the result of a research progression for a discovery of the elementary particles have a size of −18 multiplication of 10, and there is no particle state in a range from the −18 multiplication of 10 to −35 multiplication of 10, but there only exists traces of unknown energy in which a concept itself of a space as a just seeing-concept disappears.

Feeling an existence of energy may mean and can't help being finally decided as the fact that all phenomena classified into fields of physics by the humankind such as a combination and chemical reaction of material, etc., namely, the galactic system corresponding to a scale of +26 multiplication of 10, became the root for maintaining a continued existence of the universe state which exists as a type of dots.

In our ancient predecessors or Oriental philosophy it had been disputed with a dualism and a monism for the “basic principles” and the “atmospheric force” of nature, wherein the “basic principles” is an expression for a general term from a visible particle to a substance, and the “atmospheric force” is an expression for a general term of an invisible things. This can not be classified under a scientific category since a verification and an analysis are not attended with it, but if it is not overlooked that the physics is a partial portion of the philosophy, in a recent approach tendency between the Oriental and Western philosophy in an aspect that a development of a Western science is converted in mutual-reciprocity according to its necessity whether it is same in the root of the “basic principles” and the “atmospheric force”, or not, it is needed to re-consider errors of the times abandoned by a reason why the Oriental philosophy was unscientific.

Anyway the phenomenal world is constructed as a moving state and a converting state of energy, and a density of the energy makes a state and a property of the substance changed. In such phenomenon, oxygen of the substance and hydrogen of the air are converted into a state of vapor under a constant conditional state, and are converted into water as liquid and ice as solid according to a rise and a drop of temperature provided as one kind of the energy. Further a chemical reaction for gaining specific energy is represented as a metabolism reaction necessary for a living of the human and the organic bodies, and makes the substances such as gold, silver, copper, iron etc. which construct the phenomenal world with a combination of pressure, temperature and elements. It is considered there is no exaggeration to say that all the phenomena of the phenomenal world are obtained and maintained by the conversion between several kinds of energy.

In organic matter, an atomic structure is simple and an energy level within the atomic structure is week, while, a combination or a separation is easy by the chemical reaction, thus a change and a development to various shapes can be gotten. But in inorganic substance, the atomic structure is complicated and the energy level within the atomic structure is high, thus, its combination or separation is not easy and it is characterized that the inorganic substance is maintained as the original shape unless an artificial environment as a composition is provided.

However, in an aspect of a level of the elementary particle as a basic constructive substance gotten by resolving the element, there is no way to distinguish the organic matter or the inorganic substance. It can be discovered only a phenomenon that the energy level and a movement direction are differently represented, in which DNA or RNA resolve other organic matter and inorganic substance by a principle of the law of the jungle, to thus take out the required elements and generate materials required for several kinds of animals and plants as a source of the intestines, the body and energy etc., namely, to generate an electron, a proton and a neutron etc. matched with the energy level and also convert it into a substance having a peculiar characteristic. Herewith it was known that the energy level and the movement direction are decided by a wave motion moving according to a change of an environmental condition in a theory of Chaos.

Anyway it can be decided that a fountainhead of the “atmospheric force” also results in a standpoint of the monism getting united with the “atmospheric force”, but in considering that the “atmospheric force” is energy discharged according that one “basic principles” is deprived of its constructive elements corresponding to a necessary and sufficient condition for another “basic principles”, partially or all, in a fight of the law of the jungle, in a standpoint that the “basic principles” becomes the source of the “atmospheric force”, the standpoint of the dualism can't be also disregarded. That is, there is no meaning to dispute whether it is ‘1’ or ‘2’ for both sides of a circulated ring, but it should be decided as a portion of the circulated ring. Further it will be understood that an absorption and a generation of the energy are attended with the conversion of the “basic principles” and the “atmospheric force” of nature, and that the wave motion has a catalytic action for the absorption and generation of the energy.

In a procedure of observing an oxidization action of metal body, a type of energy or a figure of wave motion is radiated as a figure with characteristics of the energy and the wave motion, like figures of several kinds of energy sources introduced from the outside of the globe containing the energy source radiated from the sun to the globe. Herewith, in considering that in a spectrum analysis method, the type of energy or the figure of wave motion is represented brightly in an area named as visual rays like a characteristic of sun rays and provides an induction state till an area of low frequency or radial rays, it can be noted that the oxidization action is also a kind out of conversion procedures of energy like the sun even though there is much and/or little difference in the amount of the energy.

In our verbal expression, the conversion procedures of energy are represented as oxidization, reduction, corrosion, power generation, change, digestion, chemical combination, fermentation, calorification, fire extinguishing, a substance conversion, and a transformation etc., and we, a human, are a higher creature in the universe which uses these characteristics most usefully, meantime, it is the fact that we had neglected in trying to inquire into the root how and by which route such characteristics are provided, and to eliminate a harmfulness.

In a language a mankind expresses, there is contained mankind's history of fifty thousand years, but, unless science gets out of a pattern as a discovery and a searching examination through a procedure of statistically analyzing a phenomenon on the basis of statistics, phenomena such as a serial of atmospheric force and telepathy etc. discovered and expressed in language by the mankind with the history for fifty thousand years can not be explained, before completing the searching procedure for a long period of time in the pattern of science and also before going back to the past of the mankind history through a time-machine to follow and inquire in procedures the ancestors had experienced. Or, it is sure that the phenomena not explained in science will be forever classified as supernaturalness phenomena, unless it has the same rhythm together with the ancestors in the pattern like philosophy or sociology etc. by escaping from a frame of learning such as the science.

In the procedures of inventing and obtaining the patent for a visible rays filtering-light apparatus of this inventor provided in the Patent Publication No. 80-1563, it was discovered a phenomenon that light projected to the filtering-light apparatus had a strange scattering phenomenon and an absorption state in case that align substance was contained into the visible rays filtering-light apparatus provided under a colloid state of heavy metals, but at that time it was the phenomenon unnecessary for a manufacture of the filtering-light apparatus, thus it was just tried to eliminate the align substance without some interest, then, the same phenomenon was again observed at a chance opportunity. It was analyzed that such phenomena have a similar characteristic even though there is many and/or less differences in most substances of the natural world, and it was also observed that such characteristics continuously generate energy of a specific frequency band for a constant period like a phosphorescent or fluorescent phenomenon.

This is the phenomenon like the characteristic of a semiconductor light-emitting device, and when the energy is filtered to the specific substance to heighten a level of the energy, the level of energy is converted into a normal level to represent a light-emission characteristic corresponding to a hυ value, and among them, only a substance characteristic for emitting three elements of red, green and blue is being mainly utilized.

In case the energy is filtered to the specific substance, the same specific substance generates energy of a frequency band originated in the substance characteristic. Herewith, in the frequency filtered according to the characteristic of substance it was shown a phenomenon that only a specific frequency band aligned by the substance characteristic was selectively filtered, and it was also observed a phenomenon that a characteristic of a radiation was limitedly represented in a filtered frequency band.

Meanwhile, it was observed a case that the characteristic of substance was changed when the filtered energy became large. Thus in considering the observation for the phenomenons that according to the substances, a change of color was shown, an organized structure was changed and destroyed, or a change of weight causes a lengthening or a shortening; it was analyzed that some substance composed a combination environment for increasing the weight from the open air environment, according that the level of energy becomes high by a filtering of the energy, and that some substance composed a resolution environment for discharging partial energy, in which its internal organization is destroyed by the increase for the level of energy.

Under a status that a substance state is maintained even though it is a filtered substance of the proper amount or an excessively filtered substance, energy at a filtered frequency band is discharged. In the result a utility of the discharged energy was researched variously, it was observed that its effect was widely shown in our life everywhere, therefore it was developed an activation energy generating method and an apparatus thereof for continuously generating energy based on specific wavelength.

### SUMMARY OF THE INVENTION

Accordingly, the present invention is directed to an activation energy generating method and apparatus that substantially obviates one or more of the limitations and disadvantages of the related art.

A primary object of the present invention is to provide a method for generating activation energy and an apparatus thereof, in which energy of specific wavelength is generated continuously from a specific substance during a level of filtered energy restores to a normal state, by filtering the energy of the specific wavelength to the specific substance and so heightening the energy level.

In accordance with the present invention, and an activation energy generating unit of FIG. 1 inputs a filtering characteristic such as an energy level per substance, a radiation characteristic of filtered energy, a filtering amount, frequency and time of energy per substance, etc., and a radiation characteristic such as energy radiation amount, frequency and duration time etc. of the energy per substance, to a process control computer 12. At the same time, the activation energy generating unit performs a control so that an operational time of an energy filtering equipment 14 and a conveyor system 16 can be interlocked through a time controlling equipment 13. Thereby, an energy radiation equipment 15 manufactured in production facilities per energy radiation equipment model 18 and provided to the conveyor system 16 is sufficiently exposed to a control condition given from the process control computer 12 in the energy filtering equipment 14, to then check a quality of products, and after that, forward the products based on a good quality through a final completion inspection.

The process control computer 12 inputs (2) an inspection process, and a model number and a quantity per size and product through a process control terminal 11 when the energy radiation equipment 15 is provided into the conveyor system 16, thereby executes a control for all processes. Further, the process control computer 12 receives (3) a characteristic of raw material injected through the inspection equipment when the raw material is provided (1) as shown in FIG. 2, and is interlocked, to thus compute software having an input of a frequency range, a filtering time and an energy amount to be filtered in the energy filtering equipment, and to control (6) the energy filtering equipment and simultaneously control (5) an operation time of the conveyor system by interlocking with the energy filtering time, when the size or the model number per product etc. is inputted (4) from the process control terminal. Whereby the energy filtering equipment and the conveyor system are interlocked with each other, to then control (7) an inspection term of a forwarding Y inspection process so that products based on a good quality are forwarded and inferior products is checked (8) whether they are re-used or not. The again-unusable products are abolished, and the re-usable products are re-injected (9) into the injection process of the raw material. Such feed-back operational process is controlled by the process control computer 12.

As shown in FIG. 3, a resonance type frequency generating equipment is constructed by an energy generating equipment 19, a specific frequency guide tube 22, and an energy radiation structure 23. In case frequency is over an infrared rays area, there is a strong characteristic of a short and straight-nature in wavelength, and in a variable-type reflector lattice structure 24 based on a slant face reflection characteristic, in case that it is reflected as an angle such as an incident angle and that wavelength is deviated from a given range, it becomes a diffused reflection and is absorbed by a heat absorption type lattice structure 25, to thus generate only frequency of a specific range. The variable-type reflector lattice structure 24 is constructed to control a reflection angle, thereby the reflection angle can be adjusted so as to generate only specific frequency controlled by the process control computer 12. Also, it is herewith constructed that most energy of wide band frequency generated in the energy generating equipment 19 shielded by the lattice structure 21 becomes incident to a specific frequency guide tube 22, while, that diffused reflection frequency and potential heat not incident to the specific frequency guide tube 22 are discharged to the outside through an unwanted energy discharging aperture.

In an energy filtering equipment 14 shown in FIG. 4, an energy concentrating equipment 28 is set so that the energy filtered, matching with the size of the energy radiation equipment 15 may be concentrated, and a height controlling equipment 27 is installed to differently provide a width of beam of the filtered energy and so control an energy concentration angle ∂.

The energy radiation equipment 15 is formed in such a structure that radiation material is deposited or molded, and is covered with protection material, on the substrate, so that radiation substance can be fixed thereto. As shown in FIG. 5 the energy radiation equipment 15 is manufactured by a separate-model substrate process 29 containing a substrate raw-material selection and a material selection process, a radiation material deposition or molding 30 process containing from a radiation matter selection to a material selection process, a separate-model protection cover deposition or molding 31 containing a protection material selection and a separate-model process, and an assembling process 32 for complete the energy radiation equipment 15 by a pressure or a fusion etc. Herewith, in the substrate matter, it is proper material to which radiation energy is not absorbed, or pure metal material capable of rightly radiating the same frequency even it is absorbed. In the protection cover it is also proper material to which the radiation energy is not absorbed, or pure metal material capable of rightly radiating the same frequency even it is absorbed.

In case material requiring a partially auxiliary heat supply should become a product, there is a characteristic that heat is generated in supplying electricity in a case of pure metal, particularly, pure iron, thus the substrate or the protection cover is provided as pure metal 35 by utilizing the same characteristic as shown in FIG. 6, and it is also the structure that battery 33 power is connected through an electric wire 34. In case the electricity or frequency is required as an auxiliary supply source, as shown in FIG. 7, energy radiation material 36 is provided between plate electrode 37, and frequency generated from the frequency generating equipment 40 is supplied through a wire 38, or electricity provided from a power equipment 39 such as battery etc. is supplied.

In this present invention it was observed a radiation characteristic gotten by filtering energy to several kinds of substances, and in this result it was discovered a characteristic that energy in specific wavelength is radiated regardless of an organic matter and an inorganic matter.

A range of wavelength has two characteristics, and one is a case the wavelength corresponding to an energy level of material is radiated regardless of a range of the filtered wavelength, and another is a case that wavelength in the filtered range is radiated; which is a peculiar characteristic of the materials. That is, it can be regarded that some material selectively receives only wavelength corresponding to the peculiar vibration number of the same material from the filtered wavelength, and that some material absorbs all wavelength provided first and then discharges it.

Just, there is a case that sort wavelength deviated from the range of the filtered wavelength is radiated, which is decided that only wavelength corresponding to higher harmonics is selectively absorbed from the filtered wavelength, and then is radiated. It is also observed a case that long wavelength than the filtered wavelength is radiated, which is estimated that only a range of the long wavelength among the range of wavelength generated in the filtering procedure is absorbed, or only energy is absorbed without a concern with the filtered wavelength in an aspect of material characteristic, and then only wavelength corresponding to a peculiar characteristic belonging to an energy level is discharged in an aspect of an atomic structure of material.

Analyzing a radiation characteristic per substance, it is discovered that wavelength corresponding to an extreme outer energy level is radiated in an aspect of the atomic structure, mostly in the wavelength of the radiated energy, but in partial material, there is a case that wavelength corresponding to a second or third energy level from the extreme outer side is radiated, and also, in partial material, there is a case that energy of long wavelength longer by 2˜3 times than wavelength of the extreme outer energy level is radiated.

It was verified there was no difference for wavelength or the energy amount in the energy radiation characteristic per material based on an energy filtering time, but in a partial material, especially, in a case of non-metal inorganic matter or organic matter, there was a case that the structure of material was destroyed and its particles were broken or attended with a reduction or an increase of mass. Further, the increase and reduction phenomenon of mass was much generated in inorganic matter of iron group, which was caused by the reason why rust or dust much sticks thereto owing to an oxidization action etc. It was also known that metal inorganic matter containing an iron group was rapidly radiated when the energy was filtered, thus that there was a little of radiation energy.

As material having above-described several kinds of effects among the energy radiation characteristics per material, nonmetal inorganic matter and partial composite organic matter can be provided. When the energy is filtered to the nonmetal inorganic matter and the partial composite organic matter can be provided, it is analyzed that energy of wavelength based on a constant range is radiated uniformly for a long time, and most effects are provided by the reason why it is restricted in a range that a conversion of material is possible by an optical synthesis or a combination of organic matters, and an energy catalytic action of a small quantity.

In an observation result when filtering the energy, the more it is material corresponding to a value of 4 in a periodic table, or material based on a stabilized structure even composite material, and material higher in a neutrality extent, the more the wavelength in a filtering range is mostly radiated and is maintained for the longest time. The more it becomes near to a value 1 and a value 8 centering on a value 4 and it is composite material unstabilized and a PH consistency is high or low, the less a uniformity and a radiation period of the radiated wavelength drop. According to a strength and a homogeneous extent of material, it is analyzed that the radiation period becomes long and the afore-described effects become good.

Accordingly, it is decided that the energy radiation characteristic per material is effective when a sort of materials is provided differently according to its usage. For example, since a partial and time-limit effect is needed in a disposal of wastewater or a health auxiliary product, the maximization of the effect is realized by using watersoluble material or organic matter, and then, it is returned to nature. In utilizing such appropriate method, it will be reasonable to use the same material. In a case for power saving, it is effective to maintain the effect for a long time, matching to the same period according to a life of electric instruments, therefore it is reasonable to use material capable of maintaining an effect for a long period. In a research for models of the product to be used in soil, it was based on a decision that a use for powder of inorganic matter is reasonable by considering double effect as an environmental element and a long-period effect maintenance.

It was found in partial material, characteristics that an energy radiation period could be maintained for a long time by continuously supplying electricity of a small quantity like a luminous semiconductor, and that a radiation period could be maintained by irradiating heat or light. It is therefore expected that products based on more effect will be developed by utilizing such characteristics.

### BRIEF DESCRIPTIONS OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings:

FIG. 1 represents a block diagram showing an activation energy generating unit in accordance with the present invention;

FIG. 2 indicates an operation diagram in the present invention;

FIG. 3 depicts a resonance type frequency generating equipment of the present invention;

FIG. 4 shows a structure diagram for the structure of an inventive energy filtering equipment;

FIG. 5 is a process diagram of a radiation equipment in the present invention;

FIG. 6 provides the structure of a supplying-heat type substrate or a protecting cover in the invention; and

FIG. 7 sets forth an electric and frequency supplying type substrate and protecting cover in the present invention.

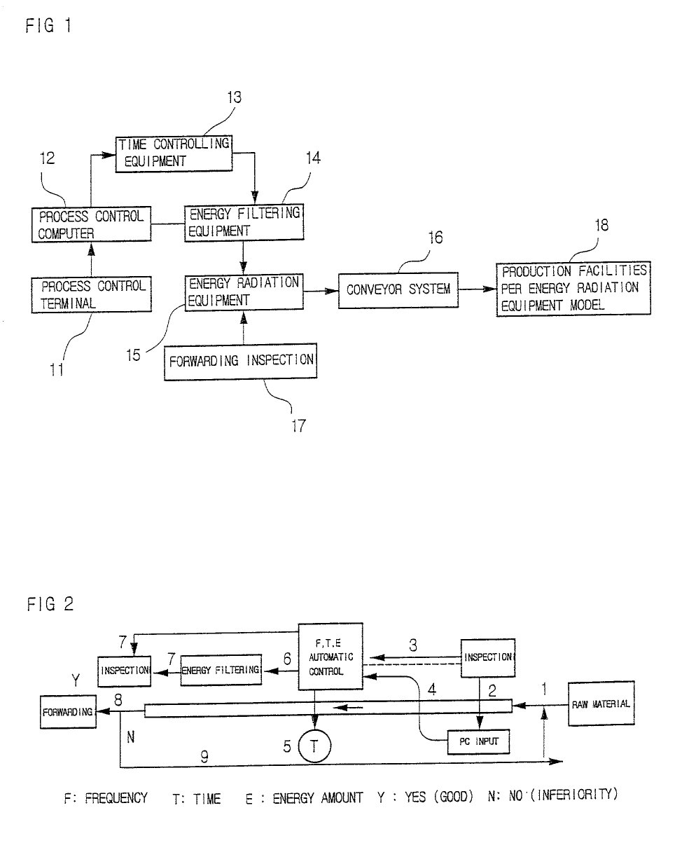

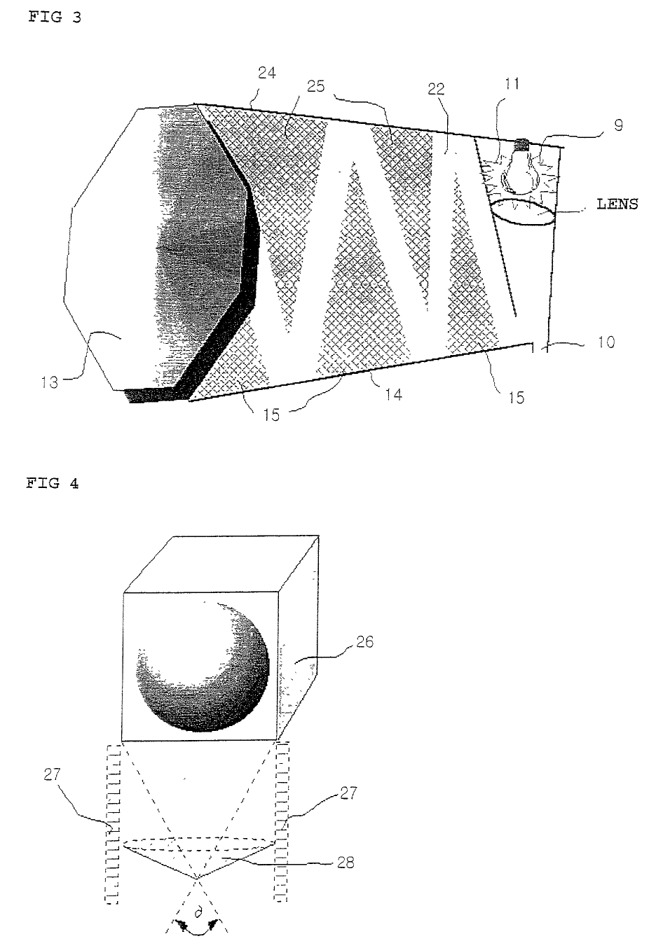

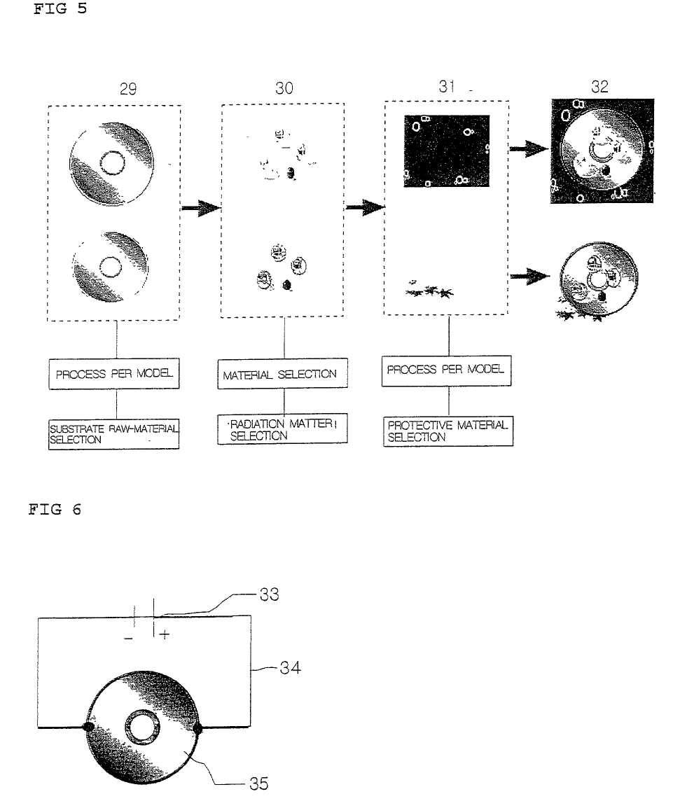

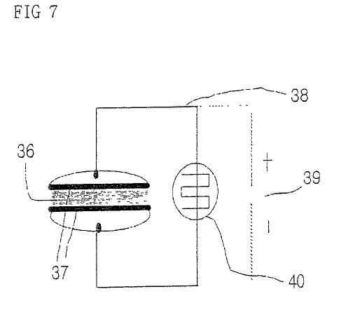

### DESCRIPTION OF THE PREFERRED EMBODIMENT

Reference will now be made in detail to the preferred embodiments of the present invention, examples of which are illustrated in the accompanying drawings.

### APPLICATION EXAMPLE 1

Power Saving Effect in Electric Application Appliances for Domestic or Industrial Use

Products with a use of electricity has been widely spread as life convenient ones indispensible to our life, but in a procedure of utilizing an energy conversion action such as a calorification, a luminescence, a rotation and a piezoelectricity etc., or of utilizing an ionization action based on a polarity effect, through an increase of voltage or a drop of voltage under a status that the electricity can not be used directly, anyone can be felt that obstacles such as noise, an obstruction of electric wave, vibration, and static electricity etc. are largely caused, as much as equaling to their convenience.

In a conversion procedure into other energy in a conversion equipment artificially made by electricity energy, a specific function of several kinds of metal bodies is utilized, and in the artificial conversion of material there is definitely generated twin material of ‘optical isomer body’ based on a chirality. It was known that such phenomenon was not represented in a nature state, and two isomer bodies were same in a physical and chemical nature, but its characteristic portion might be represented as completely objected characteristics. Further, when a hole is produced by a movement of electron, material utilized for the conversion equipment becomes a state changed to material based on a different characteristic even momentarily, till other electron fills up a place of the hole. It may be therefore, provided the phenomenon a negative (−) characteristic is more emphasized than a positive (+) characteristic, to thereby cause an obstacle cause due to the negative characteristic.

In an example for a rust generation in a case of wire, when the rust is generated, a resistance becomes large and a capacity is changed by an increase of the volume. When the resistance becomes large, a loss of energy becomes large and the lost energy is converted into other energy such as calorification, accompanying with a cause of unwanted obstruction, and the change of the capacity is represented as a phenomenon such the static electricity or a leakage electric wave generation.

When a product manufactured by the present invention is installed at a place having an energy conversion of an electric instrument, the phenomenon like the rust generation is lessened and an effect of the power saving is provided. Such effects supplies deficient electron which becomes a cause of an oxidization phenomenon causing the negative (−) characteristic together with a radiation of filtered energy, and serves as a role for restricting the oxidization phenomenon, wherein the oxidization phenomenon in electricity represents a phenomenon to take in the electron from the outside due to a shortage of the electron (−), and the rust generation indicates a state deprived of the electron according that a stabilized state of copper is maintained by taking in the electron from the open air, or indicates a state that outside material combined by a common use of the electron sticks to the copper. Herewith the rust generation is lessened and the electricity flows smoothly ultimately, thereby an efficiency of the electric instruments is heightened, and further, not only there is an effect of the power saving, but also it is lessened an obstacle cause such as noise and vibration etc provided by using the electric instruments.

### APPLICATION EXAMPLE 2

Effect of Health Auxiliary and Treatment Functions Necessary for Maintenance of Healthy Life

The human being was created and our body structure was made on earth with spirit and energy of the sun, the universe, the moon and the earth. That is, we have an organism rhythm resonant by 7.83 Hz as the peculiar vibration number decided by the universe circumstance, and when our organism rhythm is maintained according to the resonance number of the earth in a day time the sun rises, we can act most agreeably, and also, we should have a sleeping action, matching the organism rhythm with frequency of 4 Hz influenced by the moon at night, but in case there is a water vein underground so abnormal wave motion of 7˜8 Hz colliding with soil and rock, it is represented a phenomenon that we suffer from insomnia since a living body has a resonance based on frequency corresponding to the organism rhythm of the day action even night.

Meantime, the parts of the body constructing our body have in its own way the peculiar vibration number decided by an influence of the earth circumstance, for example, pulsation of 70 times in a case of the heart, and the parts of the body creates energy necessary for the body through respectively required conversion procedures, and herewith a function of taking food according to appetite is one kind out of functions for ensuring an energy source required for the body. Also an oxidization, a reduction, energy, and peculiar vibration frequency etc. are combined and a required element is taken out of the energy source, and then all remnants is discharged to the outside.

However, various elements generated in our body are extracted from the energy source just partially, and considering the fact there is much more the remnants therein, a material conversion for resolving the energy source is also artificially generated inside the body. Therefore, it can not help being considered that chirality twin material is also formed in several kinds of elements made in the body. In its example, in oxygen taken out of the lungs, the oxygen taken by an activity of a respiratory organ is usefully utilized by about 95% and then is changed to dioxide and water, then is discharged to the outside. Oxygen of about 1˜5% maintains an activation oxygen state and is continuously accumulated inside the body, to destroy mitochondrion performing a combustion action of food or destroy a carbohydrate and nucleic acid making a gene. As well-known, oxygen also becomes a main cause for making abnormal albumin and changing the body to an acidity state such as a blood circulation obstruction and cancer cell formation etc. Since the activation oxygen accumulated till adolescence is small and respective functions of the body actively activate, it is not so serious problem, but approaching to the middle years, the activation oxygen makes the body the acidity state and becomes a cause of unaccountable stress and disease.

The activation oxygen is twin material with oxygen transformed from an atomic structure partially generated in an oxygen generating procedure, and its oxidization action is large like oxygen, but falls in a combination force differently from oxygen, therefore can not perform a nourishment supply action through an oxidization and reduction action with iron etc. and has a characteristic of acidifying and destroying the nourishment comparatively week in the combination force of a molecule structure.

That is, since the activation oxygen is not completely arranged as the atomic structure like an oxygen structure, an oxygen original characteristic is transformed, to thus represent a characteristic difference like a comparison characteristic of CO₂ and CO. But, like that nitrogen carbon easily becomes a stable state of dioxide in air, the activation oxygen also becomes the stable state of the oxygen structure by a little of conditional change. While, since the activation oxygen is difficult to form such condition in the body, it is combined with organic matters week in a combination force so as to maintain its stable state. If it is for example, provided wavelength or energy having the catalytic action so that the activation oxygen may be converted into the oxygen original structure in the outside, the activation oxygen will be rapidly transformed to a figure of oxygen, and even though it was already combined with the organic matter etc. and developed to a gene transformation structure such as cancer, it is easily resolved and is metathesized to an albumin state since the combination force of the activation oxygen itself is week. In other words, the resolved cancer cell will be changed to a state of albumin not harmful upon the body anymore.

In observing an change on the body according to a lapse of time after sticking the inventive product on an abnormal portion of the body, a range of a pain portion is getting widen and then is getting gradually disappeared, or the pain disappears at any moment from a portion having the pain for a long time such as in the waste or joint. In a result of a clinical demonstration in a hospital to which the inventive products are provided partially, a common expression by most of patients is that their condition is pleasant disregard of a treatment on the abnormal portion.

Our body continuously produces innumerably much material uttered as nourishment together with metabolism, and in the metabolism procedure, several material is repeated in the conversion and replacement, and herewith our body produces not only the nourishment necessary for the body, but also its similar component, chirality twin material. Herewith, considering the facts that waste from which the nourishment was taken may be sometimes changed to toxic material harmful on the body owing to a change in properties of matter, and also considering an environmental factor that a generation of abnormal material is indispensable due to a pollution material increase of the open air environment, it can be obtained a conclusion that the expression for the pleasant condition is same as the expression which materials unnecessary for the body was lessened, and there were also in the result of the clinical demonstration, many responses that the body was same as young.

The chirality twin material or the toxic material and the abnormal material based on a pollution are mostly material of an abnormal structure deviated from an original material characteristic, the material high in the acidity degree, and also the material not converted to material of the stabilized state because of a shortage of the condition. In order to convert into the stabilized material, such material is combined with organic matter as nourishment week in the combination force or is changed to the stable state when appropriate combination material can not be found in the body, thus it invades nourishment necessary for the body or an organism of the body. At this time, material manufactured by the technique of the present invention supplies energy and wave motion so as to compose a stabilized condition required for several toxic materials and thus perform the catalytic action for the sake of a rapid stable state, and the toxic material is restored to the stable state, that is, there is no toxicity anymore, to thereby maintain a material state not harmful upon our body.

When a state of the body becomes pleasant, several kinds of intestines in our body maintain the peculiar vibration number which becomes resonant by the circumstances of the earth as a created state of the human being and makes the stable maintained. Meanwhile, if unpleasant, several intestines perform abnormal vibration in order for a maintenance for the condition of the body, and if resonant with the abnormal vibration such as water vein wave, the body becomes resonant with frequency same as activity frequency of the day even at night, and suffers from insomnia. When considering that a temper of the human being represents much changes in a day a full moon rises or a woman does a behaviour unknown even by herself, it can be noted that such phenomena are examples represented by the resonance with the very abnormal frequency. Anyway it can be gained the conclusion that the inventive product definitely becomes a help to a condition maintenance indispensible in the life of the human being.

### APPLICATION EXAMPLE 3

Effect for Disposal and Purifying Function of Several Wastewater with Heavy Metals Pollution Material

Several kinds of heavy metals melts in industrial wastewater, thus there is much difficulty in disposing and purifying the industrial wastewater. This is being pointed out as a cause of several pollution diseases and is also being embossed as a problem not solvable with money.

If constructive material of the heavy metals mixed in the wastewater is found, it can be found a process method such as a withdrawal etc., thus it is required process facilities per its generating source, but, since unknown heavy metals and organic matters of a very small amount are mixed in wastewater discharged from most of factories and homes, a heavy metals process agent is absorbed into the organic matter to cause a drop of an effect, and a microbe agent etc. as the organic matter process agent is decayed by virulence of the heavy metals. Therefore it is effective to separate and process it, but it is impossible actually. it is being represented as a recent increase tendency, that river and sea having a collection of wastewater are confronted with a problem of a composite pollution phenomenon because of a repeated precipitation of the heavy metals and the organic matter.

Most of wastewater is collected from nature, then in the organic matter, only nutrition necessary for a metabolism procedure of animals containing us, the human being, is taken, and after that, it becomes waste, and also, the inorganic matter is collected from a resources producing place and may be largely divided into one scrapped after processes of abolishing as muck and wastewater and selecting only a necessary component from a production factory, and into one scrapped after its use for our living convenience. There is no so serious problem in the abolition of the organic or inorganic matters at the resource production place since it is a portion of a circulation procedure of nature. While, it becomes the problem that a circulation procedure connected to a mass production and mass consumption causes a collection of specific material and excesses a limitation of a healing ability for nature or breaks the existing order of nature. The problem is the limitation in the healing capacity and the destroy for the existing order of nature, and the limitation in the healing capacity is mainly a concerned term with the organic matter, and the destroy for the existing order of nature is caused by an accumulation of the inorganic matters. In the organic matter it is just a bottle phenomenon of a nature circulating procedure in which the organic matter becomes a nourishment of the nature which is not harmful when the organic matter is resolved and is discarded to the nature. In the inorganic matter it is no more than an extent like moving one stone when the inorganic matter is converted into a stabilized state as a state of nature, in other words, its bad influence is not transferred to a destroy of an ecosystem. In considering such facts, it will not be caused so serious problem in pollution or wastewater if the organic matter is passed through the resolution procedure and the inorganic matter is passed through a process for a conversion to the stabilized state.

The resolution procedure of the organic matter becomes a continuous supply of a proper thermal source as energy capable of breeding the microbes, and the microbe to take charge of the resolution process is being widely distributed even any organic matter. Thus there is no problem like a supply of a specific culture fluid, but the microbe may not be lived in an atmosphere of heavy metals owing to a problem of low temperature in case that the organic matter exists in water though it is easy to supply the continuous thermal source as the energy. When considering such shortcoming, it is not surely a simple subject in composing a breeding environment.

The inorganic matter such as the heavy metals etc. has only a character necessary for a utility value among original characters of the inorganic matter itself after the process procedures in the circulation procedure, and other characters are mostly generated without any interest, for which it is a most case that massive energy should be attended for the sake of its reduction. In order to restore to the stable state, the massive energy should be absorbed from the neighborhood, which increases an oxidization action of neighboring material and makes the microbes dying, or destroys the existing ecosystem by its toxic action.

The wastewater is discarded as a mixed state of the inorganic matter such as the heavy metals and the organic matter, thus it is being caused as a difficult subject in its process for the problems that the microbes for a resolution of the organic matter die or a breeding environment is destroyed by the toxic action of the heavy metals and the energy absorption action, so the resolution can not be executed, and also that the agent for a disposal of the heavy metals is absorbed into the organic matter to thus lose its function. As one example, a negative nourishment phenomenon having green and red color generated in a lake of summer is caused according that the organic matter ferments by an increase of water temperature over the energy absorption action of the heavy metals.

The disposal of wastewater is effective after separating it into the organic matter and the inorganic matter. That is, the inorganic matters based on a minute powder state, mixed in water, have an atmosphere composition as a condition capable of generating a reduction action by using points that the organic matter is low in specific gravity and the inorganic matter is high in the specific gravity. Thereby it is induced to a material conversion of a stable state, to eliminate the toxic action of heavy metals and heighten the specific gravity so as to be precipitated, and the remained organic matter is composed as the atmosphere for resolving it in a nature state with a supply for a little of energy source, and then, a process can be completed as a plant-living state composition for performing a reduction to a re-collection of the inorganic matter or a nature ecosystem circulation process of the organic matter.

Such process can be sufficiently obtained by changing a partial process of an industrial site or a wastewater processing plant, in its analysis result. In a checking result gotten by providing the inventive product into a concerned site, it was first observed that a mixture based on a hard color mixed in the wastewater was reduced to a clean state, and then it was continuously repeated that dregs was separated into organic matter and inorganic matter and was deposited. In the deposition state, the inorganic matter was on the neighborhood to the process facilities and the organic matter was deposited on a wide range variously.

Considering such phenomenon, it is analyzed that a re-collection or a composition of a plants-living state is easy when the process equipment is constructed by a separate division-installment of a precipitation tub for the organic and inorganic matters.

In a reduction procedure of the inorganic matter such as the heavy metals etc., till now it might be a shortcoming in comparison with a process procedure of specific material in an aspect of the re-collection, according that the other inorganic matter was not processed and was discarded by passing through a substitution procedure proper to the specific material. However, in a whole aspect, all the inorganic matter was precipitated, thus it was decided a merit that the wastewater was not discarded, and that a product manufactured on the basis of the present invention was prominent in the process containing the organic matter.

The inorganic matter such as the heavy metals based on the powder state is the material of unstabilized structure purified by an artificial process, and it is minute as much as invisible and thus is easily taken into a respiratory organ circulation system or skin, and in the inside of the human body when food is taken. In case it is provided under a natural state, an oxidization-action of the inorganic matter is large so as to easily combine with organic matter having a week combination force, therefore, its volume is shown largely remarkably and is shown like floating material. Meantime, the oxidization action acts as a toxic action in the human body by destroying a portion of the human body or a nutrient etc. Since this inorganic matter harmonizes with elements of the inorganic matter and continuously performs an energy absorption action together with the oxidization action till the stable state can be maintained, it flows by a water vein layer etc. and remains as pollution material for a long time.

The oxidization action of the heavy metals disappears by absorbing it to lye or charcoal etc., which is provided by utilizing a principle that the toxicity is gone when acid material is neutralized. While, the product of the present invention utilizes an engineering method that an atomic structure is stabilized by supplying energy necessary for a change to a stable state of the heavy metals so as to eliminate the toxicity of the heavy metals.

### APPLICATION EXAMPLE 4

Activation Function for Growth Condition of Plants and Neutralization Effect of Acid Soil

Plants grows by taking nourishment and moisture from soil through an optical synthesis action and an osmotic action, and in such growing procedure it is presented self-adjusting functions through a plant-living quantity control or a growth drop or by extending its area through an area invasion of other plants group, in case the nourishment is short. According to an advance of a farming society, the nourishment such as fertilizer etc. is artificially supplied for the sake of an increase of crops, to thus change a nourishment control function to outside causes. Therefore, it is a tendency that the soil gradually loses the nourishment control function existing naturally and becomes acidified. In the acid soil, the microbes taking charge of the nourishment control function are lessened, and microbes proper to the acid soil breed to change a soil ecosystem and to thus devastate the soil as much as the crops can not be expected without agricultural chemicals or fertilizer. This is a real situation currently.

The acidification of soil and a scattering of the agricultural chemicals and the fertilizer drop a self-generation function of plants, to thus change an air environment of the neighborhood, and also drops an active growth function of the plants. Particularly, a progressing extent of the acidification in soil is higher in case that the same plants is continuously produced for several years like a hydroponic cultivation and a hothouse, than soil of a crop rotation, that is, the crops is getting lessened, or a product bad in a growth state is produced, or unexpected damages by blight and harmful insects are caused, to thereby represent even problem like giving up farming.

Soil of a natural state is near to a neutrality in a PH consistence on the basis of spring.

It is represented an acidification extent is high when it becomes autumn and harvest time, and when leaves fall and begins to corrode, it is getting gradually near to the neutrality, and then, when plants start to grow, the acidification extent again becomes high. Such phenomenon means the acidification extent was already so high that soil should absorb energy or particles corresponding to elements of nitrogen, phosphoric acid etc. from the outside, to thus maintain the neutrality, the soil being lost in its nourishment according that a plant growth takes the nourishment from the soil. It is natural that a continuous cultivation of a long time heightens the acidification extent. In order to lower the acidification extent so that the soil becomes close to the neutrality, till now it was introduced soil improvement methods such as a leaving-alone of soil for a long time, or a lye supply by a humus soil manuring incendiary fire, etc.

In the result observed by scattering or inserting the inventive product in soil, it was first shown that the number of the microbes individuals was gradually increased though it was not uniform, and that a corrosion of fertilizer or leaves mixed in the soil became high enough to see by sight. According to a lapse of time, and in comparison with a place where the inventive product is not installed, it was observed in the present invention that the plants actively grew, and that the damages by blight and harmful insects indispensably coexisting with the plants were rapidly lessened in comparison with other regions.

Soil is easy to be acidified by an influence of a serial collision or degradation and acidification etc. since the soil is mainly constructed with inorganic matters, but its neutrality is maintained by a soil corrosion through leaves falling on topsoil or an invasion of organic matters and a breeding of microbes. In a growth of plants, it takes partial elements among the organic and inorganic matters, as nourishment, from the soil, thereby a balance of the neutrality is broken and the soil becomes acidification. The acidified soil maintains the neutrality of the soil and coexists with plants and also prevents the microbes from breeding, and such reduction of the microbes results in that leaves etc. do not corrode. Therefore, the more the acidification of soil is progressed, the less an activation of the plants falls due to the reduction of the coexisting microbes and a shortage of the nourishment. That is, leaves wither and are sparse, and a fruit does not ripen or its taste drops, and further a flower loses its original figure or withers at an early time, thus a productive value is gradually lessened.

In a state that a density of soil becomes close according that the inorganic matter or the organic matter constructing the soil is combined with neighboring material in order to search for a stable state since constructive elements in the inorganic and organic matters are partially lost, and thus, in a state of the acidified soil that a flowing of moisture is hindered, the microbes can not be lived, and leaves etc. do not corrode; the product manufactured by the present invention satisfies an energy or wave motion condition necessary in changing the inorganic matter and the organic matter to a stabilized state, to provide a catalytic action so that the inorganic and organic matters may have a stabilized material structure. That is, in the inventive product the inorganic and organic matters serve as a role of cutting a ring combined with the neighboring materials, to thereby generate slits in soil and make air and moisture flowing therein, so as to restore the soil by an original natural circulation action.

In an observing and analyzing result after installing the inventive product at a hothouse farm in which a rose was continuously produced throughout the year, soil before its installment did not crumble when rubbing it with a hand, but the soil after the installment of the inventive product, after about 15 days, became so soft that there remained moisture when rubbing it with the hand. Previously the rose has withered before one week, but in the invention flower and leaves of the rose are maintained as a lively state for about 10 days. In a supplied culture fluid, there was previously much contained residual nourishment but in the invention an absorption force was getting so good that there was little of the residual nourishment. Further it was previously frequent to scatter the agricultural chemicals and change a seedling etc. on account of a problem for the damages by blight and harmful insects, but in the invention a necessity for the agricultural chemicals was lessened and it was remarkable in an effect of a crops increase since a growing state of the seedling became good.

An increase for the number of the microbe individuals was not measured and analyzed, but it was shown an earthworm and a maggot etc. which had not shown before. Considering such observation, it can be estimated that the microbes are increased and a content amount of the organic material is increased.

Meantime, there is an inconvenience to eliminate weed since the weeds crowds and grows, but it is analyzed as a good phenomenon since it is spoken for the phenomenon that a flowing of air or moisture was smooth in culture soil of the farm and it was changed to the soil where plants can grow.

### APPLICATION EXAMPLE 5

Effect of Capability Increase in Other Living Utility etc.

Vehicles is designed by the structure of circulating cooling water in order to prevent temperature of a combustion chamber from being heightened, thus rust is much generated since heat and cooling are continuously applied onto an engine during driving. In other words, it is natural to cause problems such as a noise generation and a mileage drop etc., but in a result of processing and using the cooling water with the product manufactured by the present invention, it is observed effects that the rust generation is considerably lessened, the noise is lessened and the mileage becomes good. In a case of a boiler, it is also observed the effects that the rust generation is lessened, the noise is lessened and the mileage becomes good. In a result of installing the product manufactured by the technique of the present invention in a rotation instrumental portion such as an electric fan, a refrigerator, a fluorescent light, a computer and a motor etc., it is analyzed that the noise is remarkably lessened.

Even though it can not be definitely analyzed whether the products manufactured by the technique of the present invention provide which kinds of functions, when analyzing a characteristic represented in the continuous experiment, observation and analysis procedure, it is concluded that there exists an effect overall in a part where an energy conversion is performed. In the procedure of requiring enormous energy like a conversion of material, when considering that the invention is helpful for the material to become a stabilized state despite of that generation energy of the inventive product is not so large, it is analyzed that an effect like the catalytic action is provided with a little energy source.

It is available to prove an example of helping with the conversion of material by a simple experiment. A rusted nail can be provided as its original figure when we scratch rust with knife by force and wipe it, but in a case reduced to a product manufactured by the technique of the present invention, it can be clarified that it is reduced with only a very small quantity without a specific trying. In comparing with the provided endeavor and energy amount, there is an exorbitant difference, therefore, it can not help being explained as the fact that the inventive product performs the catalytic action for promoting self-generation force of material itself, rather than a searching for the stable state of material with only a supply of energy. That is, it becomes the basis that a decision except the above fact can not be gained, when seeing a resolution figure of rust stuck to the nail.

In considering a state that we maintains our life with a large number of conversion and reduction actions in our usual life and all things in the universe coexist through a large number of conversions and reductions, and also considering that the inventive product is the goods for smoothly helping with the conversion and reduction, it is regarded its effective value is unlimited. Actually, at a place where the inventive product is installed, it can be felt a refreshing feeling that air becomes limpid and unpleasant smell disappears. It is further observed an environmental change in our living neighborhood, that is, it is felt that food is maintained in the degree of freshness for a long time and becomes taste good, and a mild taste is felt when drinking an intoxicant high in an alcoholic consistency, or a fluorescent light becomes clear, etc.

As afore-mentioned, in accordance with the present invention, in electric application appliances for domestic and industrial use, as units for continuously generating energy of specific wavelength from specific material, there are a power saving effect, an effect of a health auxiliary and remedying function, a disposal and purifying function effect for several kinds of wastewater mixed with heavy metals pollution material, a living condition activation function of plants and a neutralization effect of acidification soil, and a functional effect in other living neighborhood convenient facilities etc.

It will be apparent to those skilled in the art that various controls and variations can be made in the present invention without deviating from the spirit or scope of the invention. Thus, it is intended that the present invention cover the controls and variations of this invention provided they come within the scope of the appended claims and their equivalents.

What is claimed is:

1. An apparatus for generating activation energy, characterized in that:
an energy filtering equipment for filtering energy of specific frequency is constructed in an energy radiation equipment for discharging the energy of the specific frequency filtered for a constant period when the energy of the specific frequency is filtered; and
an installment of the energy filtering equipment and its inspection process, a conveyor system interlocked with the energy filtering equipment through a time controlling equipment, and a forwarding inspection process are combined with one another,
wherein said energy filtering equipment is automatically controlled by a process controlling computer operating by a process control terminal to which frequency corresponding to an energy level per radioactive substance, and an energy amount and a filtering time are gotten in program and are inputted.

2. The apparatus of claim 1, wherein said energy filtering equipment is constructed by a combination of a height controlling equipment and an energy concentrating equipment, and has the construction for controlling an energy concentration angle so that the energy of the specific frequency generated from a resonance type frequency generating equipment may be interlocked according to a size of the energy radiation equipment.

3. The apparatus of claim 2, wherein said resonance type frequency generating equipment is characterized by the construction that energy generated from an energy generating equipment which is shielded with a lattice structure is mostly irradiated into a specific frequency guide tube, so as to provide the structure that an irradiation and a reflection are repeatedly performed by several times in a variable type reflector lattice structure, to thus generate only energy within a range of the specific frequency to the outside through an energy radiation structure;
said variable type reflector lattice structure is constructed to become variable, matching to wavelength of the specific frequency, and to thus repeat the irradiation and the reflection in only the range of the specific frequency so that unnecessary frequency is cut off, and is also constructed by the characteristic that unnecessary scattered frequency is absorbed in a heat absorption type lattice structure, and that energy scattered and not irradiated into the specific frequency guide tube, among the energy generated from the energy generating equipment, is discharged to the outside through an unwanted energy discharging aperture.

4. The apparatus of claim 1, wherein a substrate or a protective cover of said energy radiation equipment is provided as a pure metal substrate, and has the construction that power of a battery etc. is supplied through an electric wire, said energy radiation equipment being for utilizing material which requires heat as an auxiliary energy supplying source from a specific energy radiation equipment.

5. The apparatus of claim 1, wherein said substrate or said protective cover of said energy radiation equipment is provided as a plate electrode, and has the construction that energy radiation material is positioned between the plate electrode, and electricity or frequency generated from a frequency generator or a power equipment such as the battery etc. is supplied through the electric wire, said energy radiation equipment being for utilizing material which requires the electricity or the frequency as the auxiliary energy supplying source from the specific energy radiation equipment.

6. A method for generating activation energy, comprising the steps of:
generating continuously energy of specific wavelength from specific material during a level of filtered energy is reduced to a normal state by filtering the energy of the specific wavelength to the specific material and heightening the energy level.
